(19) United States
(12) Patent Application Publication
(10) Pub. No.: US 2002/0105808 A1
(43) Pub. Date: Aug. 8, 2002

(54) Illuminated revolving lamp device

(76) Inventor: Patrick Lau Ting Yup, Quarry Bay (HK)

Correspondence Address: CHAPMAN AND CUTLER, 111 WEST MONROE STREET, CHICAGO, IL, 60603, US

(21) Appl. No.: 10/044,400

(22) Filed: Jan. 11, 2002

Related U.S. Application Data
(60) Provisional application No. 60/261,556, filed on Jan. 12, 2001.

(51) Int. Cl. F21V 1/10; F21V 17/02; F21V 9/10; G09F 13/36

(52) U.S. Cl. 362/281; 362/284; 362/293; 362/323; 362/324; 362/360; 362/806; 40/431; 40/503

(57) ABSTRACT

An illuminated revolving lamp device having a rotating translucent member surrounding a source of light and bearing colored patterns thereon, and a second translucent member formed with grating portions of various transmissiveness, the second translucent member adjacent first translucent member such that when the display device is viewed from a fixed location, a changing display of colors and shapes is observed.

### CLAIM TO PRIORITY

The priority of the provisional application filed by the present inventor on Jan. 12, 2001, as serial No. 60/261,556, entitled ILLUMINATED REVOLVING LAMP DEVICE is hereby claimed under 35 U.S.C. § 119-120.

### BACKGROUND OF THE INVENTION

1. Field of the Invention

This invention relates to illuminated colored display devices, and more particularly to a display device which presents the visual effect of changing patterns and size of shapes when viewed by an observer.

2. Description of Related Art

Various types of ornamental illuminated display devices have been provided in the past. Some of these devices have obtained a desired visual effect of changing light patterns by passing light through liquids contained within transparent housings located between the viewer and the source of light. Two or more liquids of different colors may be utilized, with air bubbles being passed through the liquids to provide changing colors and patterns. Typical of such devices are those shown in U.S. Pat. Nos. 3,613, 264—Vitka et al.; U.S. Pat. No. 3,706,149—Olivieri; and U.S. Pat. No. 3,964,194—Gugeler. For instance, the Gugeler patent describes a changeable color device wherein an illumination source is located within three concentric cylinders formed of a light transmissive material, between pairs of which air is bubbled through a liquid.

Other ornamental illuminated display devices have obtained the desired visual effect of changing light patterns by causing the movement of one or more light transmissive means of varying shapes and colors with respect to the light source. Typical of such devices are those shown in the following United States patents: U.S. Pat. No. 5,685,097—Marinov, U.S. Pat. No. 2,867,716—Ream; U.S. Pat. No. 3,791,058—Mollica; U.S. Pat. No. 3,179,791—Mole; U.S. Pat. No. 5,065,289—Teng; U.S. Pat. No. 3,686,494—Naylor; U.S. Pat. No. 5,394,309 —Brown.

U.S. Pat. No. 5,685,097 discloses an ornamental display device wherein a light is located in the center of a pair of relatively rotating screens. An external translucent member substantially surrounds the inner graphic designs and creates a magnifying effect so as to provide the appearance or illusion of motion between the interaction of the images on the internal rotating screens.

The Ream patent discloses an ornamental display device wherein a bulb is located in a rotating drum which is provided with perforations through which light projects to a clear plastic cylindrical shell. The Mole patent describes an illuminating device wherein three lens of different colors are mounted in a triangular form on a support which rotates about a light source. The light passing through the lens also passed through an aperture formed in the spherical housing containing the light source and lens.

The Naylor patent illustrates a lighting apparatus wherein two concentric cylindrical light transmissive members having designs thereon are caused to counter-rotated around a light source. The heat generated by the light source causes air currents to engage blades secured to the cylinders to cause them to rotate. The Mollica patent sets forth a device for providing visual effects including a source of black light located within a rotatable hollow cylindrical translucent element having a pattern thereon subject to fluorescence. The translucent element is surrounded by a cylindrical lens which is located within a translucent rectangular housing.

The Teng patent reveals a display device which includes a crystal ball having a plurality of concave and convex portions which when filled with water form concave and convex lens through which is observed a decorative article within the ball. The ball is caused to rotate with respect to the base on which it is supported. The Brown patent is directed to a submersible device for changing colors in an aquarium, wherein a domed member having transparent plates of varying colors is caused to rotate around a light source, with the light of varying colors projecting into the water through clear transparent windows in a housing enclosing the device.

### SUMMARY OF THE INVENTION

It is an object of this invention to provide an illuminated rotating lamp device which presents the visual effect of changing patterns or shapes when viewed by an observer.

It is a further object of this invention to provide an illuminated rotating lamp device which is readily adapted to provide changing shapes in different hues and in different changing patterns.

It is a still further object of this invention to provide such an illuminated rotating lamp device which is readily assembled from limited number of components which are readily manufactured.

It is still another object of the invention to provide such an illuminated rotating lamp device which uses multiple colors and/or themes to provide a pleasing and enjoyable visual effect when it is operated and viewed by an observer.

In accordance with this invention an illuminated revolving lamp device is provided which includes a base, and at least one inner translucent member which is supported on a turntable, which is in turn supported by the base and are rotated with respect to the base by a drive system included in the base. The translucent member, which in the preferred embodiment is of a cylindrical or frustum shape, surrounds a source of illumination, which is also supported on the base. Colored patterns are provided on the translucent member. A second external, translucent member, which is supported on the base in a fixed position is of the same general shape, but is formed with regions of varying transmissivenes or grating or lines to provide a visual effect which varies the visible portions of the inner member. An opaque cover is supported on the external translucent member over the ends of all of the translucent members. The translucent members may be removed from the base to gain access to the source of illumination which in the preferred embodiment is an electric light bulb.

Other objects and further details of this invention will be set forth my making reference to the following drawings and specification.

### BRIEF DESCRIPTION OF SEVERAL DRAWINGS SHOWING ALTERNATIVE CONSTRUCTIONS OF THE BASE AND OTHER MEMBERS

FIG. 1 is a perspective view of the illuminated revolving lamp device in accordance with the present invention;

FIG. 2 is another perspective view of the illuminated revolving lamp device in accordance with the present invention;

FIG. 3 is a top plan view of the revolving lamp decorative device in accordance with the present invention;

FIG. 4 is a cross-sectional view of the illuminated revolving lamp device taken generally along the lines 4-4 in FIG. 1; and

FIG. 5 is an exploded view of a portion of the external and internal elements of the illuminated rotating lamp device showing the interaction of the graphical elements.

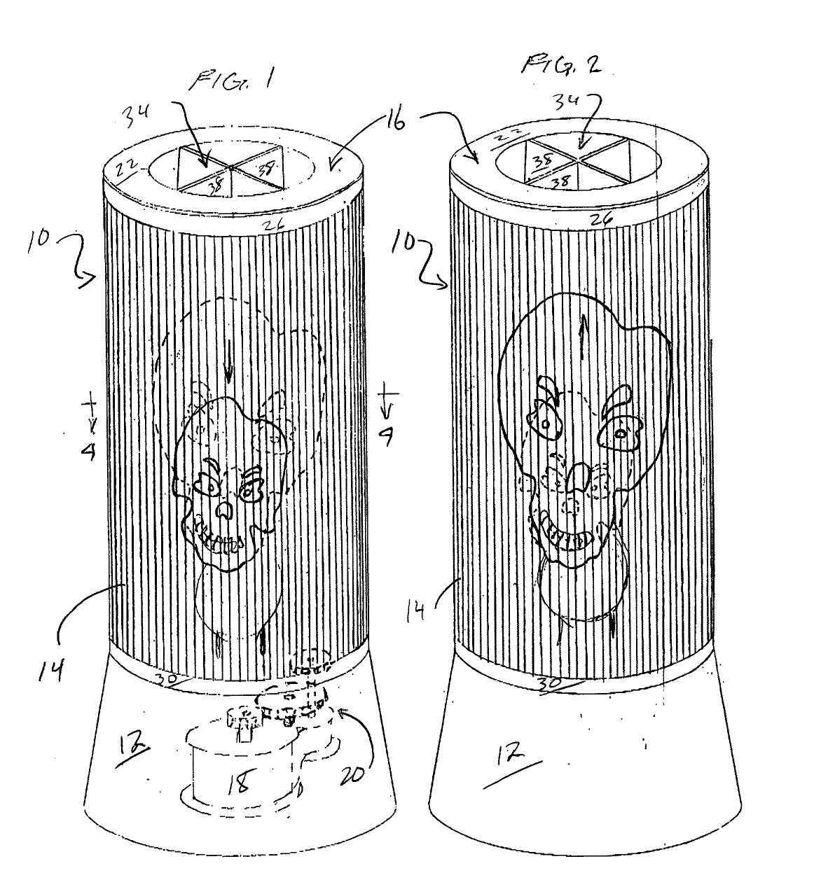

### DETAILED DESCRIPTION OF THE EMBODIMENT SHOWN IN FIGS. 1-4

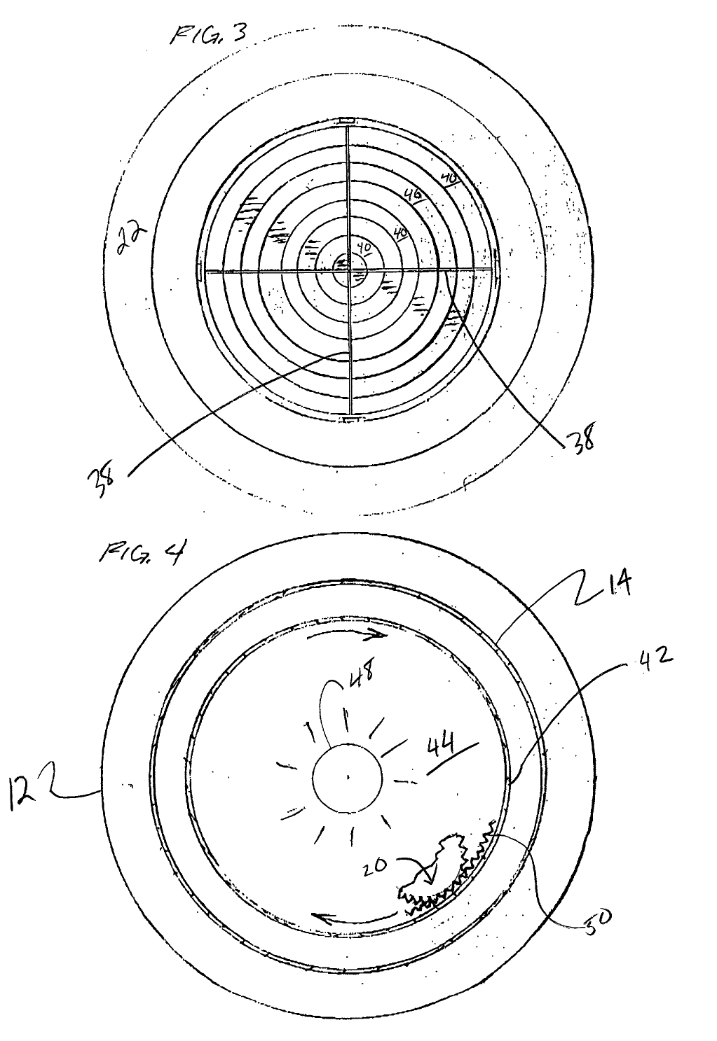

Referring to FIGS. 1 and 2, preferred embodiment of the illuminated rotating lamp device 10 is shown, generally designated by the numeral 10. The principal components of the rotating lamp are a base 12 and outer cylindrical, partially transparent or translucent member 14 and an end cap or top cover 16. The base portion 12 is generally frusto-conical in shape and preferably opaque so that internal mechanical elements, as shown on phantom in FIG. 1, are not viewable to the observer. In the preferred embodiment an electrical motor 18 and drive train 20 are utilized to create a moving effect as will be described in greater detail hereinafter. If desired, a number of feet (not shown) can be provided on the bottom of the base 12 to provide support.

In the preferred embodiment, the cap 16 includes an annular ring portion 22 which carries a depending flange 26, which in the preferred embodiment fits within the outer translucent member 14 and may be secured by a detent mechanism or appropriate adhesive. Similarly, a lower ring and flange 30 is provided between the junction of the outer member 14 and the base 12 and is similarly secured via the flange to the cylindrical member by suitable attachment means. The cap 16 and the lower ring 30 are typically made of resilient plastic and add integrity and rigidity to the outer element 14 so it can retain its cylindrical shape. The lower ring removably connects the outer member 14 to the base 12. As will be seen in greater detail hereinafter, the outer cylindrical element 14 is made of a thin, rather flexible “film” or suitable material.

As can be seen in FIGS. 1, 2 and 3, the cap 16 includes a circular inner element generally designated 34 which is designed to be removable, utilizing a breach lock or similar mechanism. The inner portion 34 includes a pair of crossed shaped flanges 38 which provide easy gripping and rotating of the inner element to disconnect it from the outer ring 22. In addition, as more clearly shown in FIG. 3, a plurality of integrally molded annular rings 40 are connected to the crossing elements 38 to provide a combination of annular openings therebetween to provide ventilation.

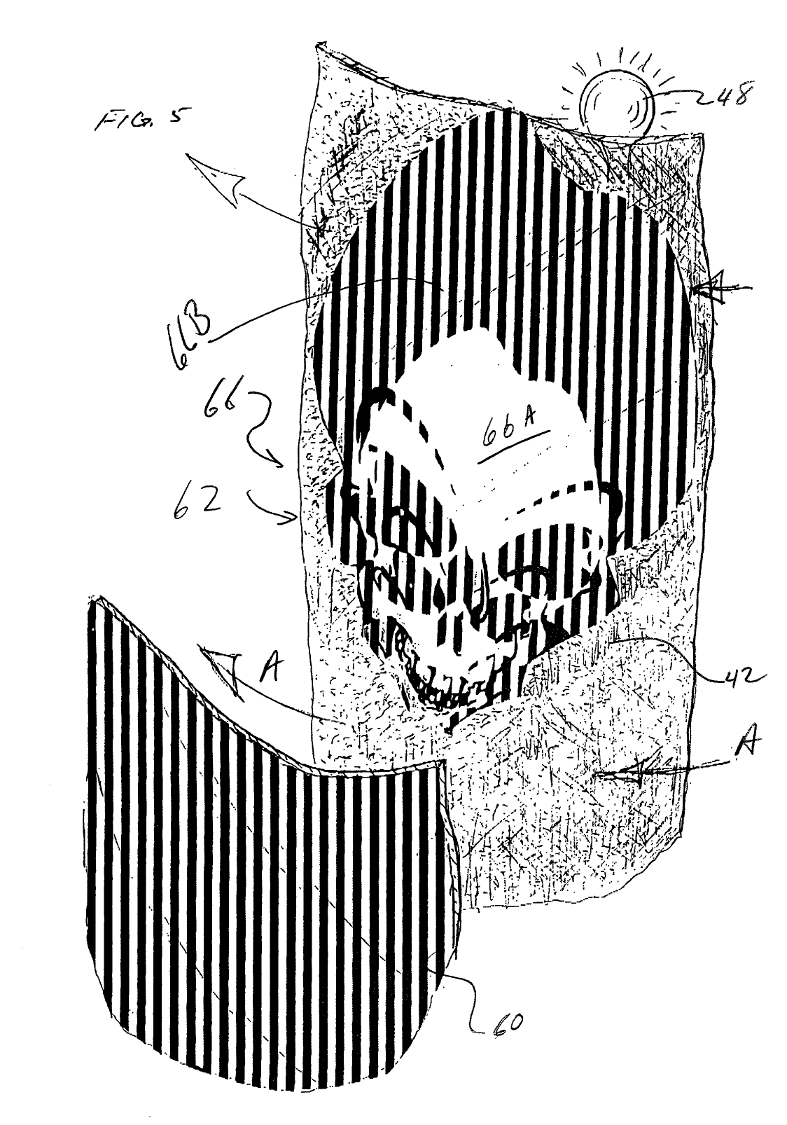

Referring now to FIG. 4, which is a section taken generally along line 4-4 of FIG. 1, it can be seen that internally of the outer translucent member 14 is an inner translucent member 42 mounted on a rotatable platform 44. A source of illumination, such as a light bulb 48 is mounted in a socket above the rotatable platform 44 within the inner translucent element 42 to provide a light source for light to emanate therefrom through the inner element 42 and outer element 44. As depicted near the bottom of FIG. 4, the drive train 20 is shown partially exposed where it engages an inner toothed ring 50 on the rotatable platform to rotate the inner translucent sleeve 42 mounted on the platform 44 relative to the base and the outer sleeve 14. The motor 18 rotates continuously but could be a stepper motor if desired. In this manner, when the rotating lamp is viewed by an observer, light travels from the source of illumination 48 through the inner sleeve 42 and through the outer sleeve 44 to the eyes of the observer. The source of illumination 48 is typically mounted in an electrical lamp socket on the axis of the rotating platform 44 but the socket itself does not rotate and it is electrically connected in a conventional manner to the same source of power connected to the motor 18. The structure therefore defined and described provides a rotating lamp device with an internal electrical bulb, a rotating inner translucent sleeve and a stationary cylindrical outer translucent sleeve. The interaction between the graphics on the respective sleeves as the inner sleeve is rotated relative to the outer sleeve create the special, changing, graphical effects observed by the user.

In particular, a portion of the outer translucent cylindrical sleeve is shown in the bottom left hand portion of FIG. 5. In the preferred embodiment, this sleeve includes a grating or striated design wherein a plurality of opaque or black parallel lines 60 are provided in the longitudinal direction on the outer sleeve 14 so that the observer actually “observes” primarily the portions of the inner sleeve 42 that are visible between the grating lines 60 where the outer sleeve is transparent. In the preferred embodiment, the thickness of the grating lines 60 is approximately equal to or less than the clear spaces therebetween.

In order to create the effect or illusion of movement by the interaction between the inner and outer sleeves 14 and 42, multiple images such as that designated as 62 in FIG. 5 are provided on the inner sleeve 42. The multiple images, in this case as shown in FIG. 5, of a skull, generally designated 66, is provided. The multiple images of the skull 66 can, for example, include a small FIG. 66A and a large FIG. 66B and the small and large figures are provided in an overlapping fashion but offset in direction of rotation as shown by the arrows A in FIG. 5 by an amount approximately equal to the width of the vertical lines 60 so that when in a first position, such as that shown in FIG. 1, the small image of the skull 66A is viewable and when the inner sleeve 42 is rotated so that the larger image of the skull 66B aligns and is visible through the transparent portions of the outer sleeve the larger version of the skull 66B is visible. Therefore, as the inner sleeve rotates relative to the outer sleeve the image appears to oscillate or flash back and forth between the small and large versions of each image. Multiple images are provided on each inner sleeve so that a series of continuing, flashing or changing or moving or jumping images is seen by an observer viewing the rotating lamp from a stationary position.

While a particular embodiment has been shown and described, it would be apparent to one skilled in the art that the particular shape of the base 12 and the translucent members 14 and 42 could be readily changed as could the pattern of colors and colors provided on the internal translucent member 42 and the design of or shape of the striations on the outer translucent member 14. In order for the invention to work as intended, what is needed is for multiple patterns on the inner sleeve to be provided such that a first pattern overlaps but is spaced from a second pattern approximately by the width of the transparent spaces on the outer sleeve. In this way, a first image is seen by the observer and then after the relative movement between the two sleeves occurs, the second image is seen by the observer. This really works well and the effect is easily seen by an observer when a constantly rotating motor 18 is used to rotate the sleeves relative to one another. It is not important which sleeve rotates, but merely that there is relative movement. Also, as explained previously a stepper motor could be used whereby the relative movement is incremented by the width of the transparent portion of the outer sleeve, so that first one image would be seen and the sleeves would be incremented quickly by the stepper motor and momentarily stopped at a second position where the second image would be seen. This design may not be as economical because of the additional cost, but could provide certain benefits.

It should also be pointed out that, although the embodiment shown describes two cylindrical sleeve portions, the invention is not limited to cylindrical elements. For example, both could be frusto-conical in shape or they could be generally elongated, flat rolls stretching around rollers at opposite ends. All that is necessary is that an illumination source project the indicia or images on the inner portion through the grated outer portion so that multiple images are alternately seen by the observer.

To assist in the understanding of this description and the potential designs for the inner sleeve portion 42, enclosed herewith is an appendix of five pages including a sheet identified “Patter of Cylinder,” a second entitled Final Colored Film Sheet 1, a third entitled Final Colored Film Sheet 2, another entitled Final Colored Film Sheet 3 and a final entitled Final Colored Film Sheet 4. The external translucent member 14 has a graded or striated pattern such as that shown in the black and white sheet of the appendix marked “Pattern of Cylinder.” The pattern on the cylinder 14 and the grating thereon provides a special effect since at any point in time only a portion of the indicia on the inner translucent member 42 are visible; thereby, the observer sees an image from the inner translucent member 42 through the external translucent member 14 which appears to vary in shape and/or size as the inner translucent member rotates relative to the outer translucent member. It should be noted that the same effect can be achieved if the inner translucent member is stationary and the outer translucent member rotates or if both of the translucent members 14 and 42 rotate at different relative rates. The images from the inner translucent member 42 are projected by the light from the illumination source 48 through the graded external translucent member 14 so that only a portion of the images are visible at any point in time. The indicia on the inner translucent member 42 thereby works in a cooperative fashion to permit a portion of the indicia thereon to be projected through the outer translucent member 12 between the grating lines 60 causing the appearance of the figures on the inner translucent members to oscillate or vary in shape and size as the inner translucent member 42 moves relative to the external or outer translucent member 12. As would be obvious to one skilled in the art, an infinite number of inner translucent members 42 could be designed to create the changing pattern effect that occurs as the inner translucent member is rotated with respect to the outer translucent member by a drive system similar to that shown and described in FIG. 1.

In the current preferred embodiment, various colored sheets are enclosed in the appendix. The color sheet entitled “Final Colored Film Sheet 1” depicts a “Halloween scene” of fanciful skulls, bats and other elements typically associated with Halloween. The Final Colored Film Sheet 2 depicts a “Batman” scene with Batman and Robin and other characters. The Final Colored Film Sheet 3 depicts a number of butterflies and flowers and the Final Colored Film Sheet 4 depicts certain of the Powerpuff Girls from the Cartoon Network series. As explained above, any number of designs are possible, but it can be seen that the variation in the designs permits the appearance of movement to the observer when viewed through the outer translucent member to create a pleasing changing or special effect when viewed by the observer.

It should be apparent to those skilled in the art that while what has been described are considered at present to be the preferred embodiments of the illuminated rotating lamp display device of this invention, in accordance with the patent statutes, changes may be made in the illuminated colored display device without actually departing from the true spirit and scope of this invention.

The appended claims are intended to cover all such changes and modifications which fall within the true spirit and scope of this invention.

### Appendix

What is claimed is:

1. An illuminated rotating lamp device comprising:
a base;
a source of illumination supported on said base;
a first translucent member supported on said base, said first translucent member having a pattern formed thereon;
a second translucent member supported on said base with portions of various transmissiveness; and
a drive system for moving said first translucent member with respect to said second translucent member, whereby the illumination from said source of illumination as observed through said second translucent member is a varying pattern of shapes depending upon the relative positions of said first and second translucent members with respect to each other.

2. The illuminated rotating lamp device of claim 1, wherein said first and second translucent members are of a generally cylindrical shape, with said second translucent member being of a larger diameter than the first translucent member.

3. The illuminated rotating lamp device of claim 1, wherein said first and second translucent members are of a frustum shape, with said second translucent member being of a larger diameter than the first translucent member.

4. The illuminated rotating lamp device of claim 1, wherein said first translucent member has a pattern formed thereon of at least two different colors.

5. The illuminated rotating lamp device of claim 1, wherein one of said first and second translucent members has a pattern formed thereon by two transparent colored portions and a clear portion, with portions of said two colors overlying each other.

6. The illuminated rotating lamp device of claim 1, wherein said translucent members are formed of transparent colorless base, with said pattern of colors being applied thereto.

7. The illuminated rotating lamp device of claim 1, wherein a first end of said second translucent member is supported on said base, and a cover is secured to a second end of said second translucent member.

8. The illuminated rotating lamp of claim 1, wherein said drive system causes said first translucent member to move in a first direction relative to the base.

9. The illuminated rotating lamp device of claim 8, wherein said drive system includes first and second counter rotating gears and a first turntable for supporting said first translucent member for relative rotation with the base.

10. The illuminated rotating lamp device of claim 1, wherein said source of illumination is electrically energized.

11. An illuminated rotating lamp device comprising:
a base;
a drive system;
an illumination;
a first translucent member having portions of different indicia around said illumination source; and
a second translucent member adjacent said first translucent member, said second translucent member having portions through which said illumination passes, said drive system causing said first translucent member to move with respect to said second translucent member, whereby the color and pattern of the illumination emitted through said second translucent member is of a changing appearance when observed from a fixed position spaced from the lamp.

12. The illuminated rotating lamp device of claim 11, wherein said first and second translucent members are of a generally cylindrical shape, with said second translucent member being of a larger diameter than the first translucent member.

13. The illuminated rotating lamp device of claim 11, wherein said first and second translucent members are of a frustum shape, with said second translucent member being of a larger diameter than the first translucent member.

14. The illuminated rotating lamp device of claim 11, wherein said first translucent member has a pattern formed thereon of at least two different colors.

15. The illuminated rotating lamp device of claim 11, wherein one of said first and second translucent members has a pattern formed thereon by two transparent colored portions and a clear portion, with portions of said two colors overlying each other.

16. The illuminated rotating lamp device of claim 11, wherein said translucent members are formed of transparent colorless base, with said pattern of colors being applied thereto.

17. The illuminated rotating lamp device of claim 11, wherein a first end of said second translucent member is supported on said base, and a cover is secured to a second end of said second translucent member.

18. The illuminated rotating lamp of claim 11, wherein said drive system causes said first translucent member to move in a first direction relative to the base.

19. The illuminated rotating lamp device of claim 11, wherein said drive system includes first and second counter rotating gears driving a first turntable for supporting said first translucent member for relative rotation with the base.

20. The illuminated rotating lamp device of claim 11, wherein said source of illumination is electrically energized.

21. A motion lamp comprising:
a base;
a drive system on the base;
an illumination source supported on said base;
a first translucent member having portions of different, related indicia supported on said base; and
a second translucent member adjacent said first translucent member and supported on said base, said second translucent member having complimentary portions through which said illumination passes, said drive system causing said first translucent member to move with respect to said second translucent member, whereby a pattern of the illumination emitted through said second translucent member is of a changing effect when observed from a fixed position spaced from the lamp.
